(19) United States
(12) Patent Application Publication
(10) Pub. No.: US 2026/0235941 A1
(43) Pub. Date: Aug. 13, 2026

(54) ILLUMINATION SYSTEM AND A PROJECTION DEVICE

(71) Applicant: Coretronic Corporation, Hsin-Chu (TW)

(72) Inventor: Yu-Hsiang DENG, Hsin-Chu (TW)

(21) Appl. No.: 19/455,840

(22) Filed: Jan. 22, 2026

(30) Foreign Application Priority Data
Feb. 7, 2025 (CN) 202510135852X

(51) Int. Cl. G03B 21/20

(52) U.S. Cl. CPC G03B 21/208; G03B 21/2013; G03B 21/2033; G03B 21/2073

(57) ABSTRACT

The disclosure is related to an illumination system for providing an illumination light beam. The illumination system includes a light source module, a light spot adjustment module and a homogenizing module. The light spot adjustment module includes a first lenticular lens and a second lenticular lens. A spatial distribution relative to a reference plane forms a light spot area while the red beam is incident on the first lenticular lens. An angular distribution relative to the reference plane has a major axis while the red beam is incident on the first lenticular lens. An extension direction of the major axis is the same as a column body extension direction of the first and second lenticular lenses. The light spot adjustment module is configured to reduce the light spot area. The illumination system and the projection device of the disclosure may increase the etendue utilization of the homogenizing module.

### CROSS-REFERENCES

This application claims the priority benefit of Chinese Patent Application Serial Number 202510135852X, filed on Feb. 7, 2025, the full disclosure of which is incorporated herein by reference.

### TECHNICAL FIELD

The disclosure is related to optical systems and electronic devices. More particularly, the embodiments are related to an illumination system and a projection device.

### DESCRIPTION OF RELATED ART

A projection device (such as a projector) is a display device for generating a display image. The imaging principle of the projection device is to convert an illumination light beam generated by the illumination system into an image beam through a light valve and to project the image beam onto a projection surface such as a screen or a wall through a projection lens. Light emitting diodes or laser diodes may be used as a light source of the illumination system of the projection device for providing the illumination light beam. Laser diodes are widely used as the light source of a projection device due to their advantages such as high efficiency, small size and better color performance.

Generally, the illumination system includes a homogenizer. The homogenizer is configured to homogenize the brightness distribution of the beam emitted from the light source. However, a red laser diode is limited by the manufacturer's design and usually emits light from two chips. As a result, an angular distribution of a red beam emitted from the red laser diode has different major axial length and minor axial length when the red beam is incident on the homogenizer. Thus, the etendue utilization of the homogenizer is low.

The information disclosed in this DESCRIPTION OF RELATED ART section is only for enhancement of understanding of the background of the described technology and therefore it may contain information that does not form the prior art that is already known to a person of ordinary skill in the art. Further, the information disclosed in the DESCRIPTION OF RELATED ART section does not mean that one or more problems to be resolved by one or more embodiments of the disclosure was acknowledged by a person of ordinary skill in the art.

### SUMMARY OF THE INVENTION

The embodiment of the disclosure provides an illumination system and a projection device to allow a spatial distribution of a red beam to be reduced when the red beam is incident on a homogenizing module, so that an etendue of the red beam to be reduced. Therefore, the utilization of the etendue of the homogenizing module is improved.

In order to achieve the above object and other related objects, the disclosure provides an illumination system for providing an illumination light beam. The illumination system includes a light source module, a light spot adjustment module and a homogenizing module. The light source module is configured to provide a red beam, a green beam and a blue beam at different timings. The light spot adjustment module is disposed on a transmission path of the red beam which is transmitted from the light source module to the homogenizing module. The light spot adjustment module includes a first lenticular lens and a second lenticular lens. The first lenticular lens is disposed on a transmission path of the red beam which is transmitted from the light source module to the second lenticular lens. The first lenticular lens includes a first surface with a variable curvature. A curvature of the first surface changes along a first direction. The second lenticular lens is disposed on a transmission path of the red beam which is transmitted from the first lenticular lens to the homogenizing module. The second lenticular lens includes a second surface with a variable curvature. A curvature of the second surface changes along the first direction. A column body extension direction of the first surface and a column body extension direction of the second surface are parallel to a second direction. The second direction is perpendicular to the first direction. The first direction and the second direction form a reference plane. A spatial distribution of the red beam relative to the reference plane forms a first light spot area while the red beam is incident on the first lenticular lens. An angular distribution of the red beam relative to the reference plane has a major axis while the red beam is incident on the first lenticular lens. The major axis is parallel to the second direction. The light spot adjustment module is configured to reduce the light spot area. The homogenizing module is configured to receive the red beam from the light spot adjustment module, the green beam and the blue beam and to homogenize the green beam, the blue beam and the red beam to generate the illumination light beam.

In order to achieve the above object and other related objects, the disclosure provides a projection device. The projection device includes the illumination system mentioned above, a light valve and a lens module. The illumination system is configured to generate the illumination light beam. The light valve module is disposed on a transmission path of the illumination light beam for converting the illumination light beam into an image beam. The lens module is disposed on a transmission path of the image beam. The lens module is configured for projecting the image beam from the light valve module out of the projection device.

According to the above, the embodiments of the disclosure have at least one of the following beneficial effects: The embodiment of the disclosure provides an illumination system and a projection device to allow a spatial distribution of the red beam relative to a homogenizing module to be reduced while a red beam is incident on the homogenizing module, so that an etendue of the red beam to be reduced while a red beam is incident. Therefore, the utilization of the etendue of the homogenizing module is improved.

Other objectives, features and advantages of the disclosure will be further understood from the further technological features disclosed by the embodiments of the disclosure wherein there are shown and described preferred embodiments of this disclosure, simply by way of illustration of modes best suited to carry out the disclosure.

### BRIEF DESCRIPTION OF DRAWINGS

FIG. 1 is a block schematic of a projection device according to an embodiment of the disclosure.

FIG. 2A is a schematic of a projection device according to an embodiment of the disclosure.

FIG. 2B is a schematic of a projection device according to another embodiment of the disclosure.

FIG. 3 is a schematic of a timing of a light beam according to an embodiment of the disclosure.

FIG. 4 is a schematic of a laser module according to an embodiment of the disclosure.

FIG. 5 is a schematic of a first light combining element according to an embodiment of the disclosure.

FIG. 6 is a schematic of a light spot adjustment module according to an embodiment of the disclosure.

FIG. 7 is a schematic of a first light spot area on a reference plane while a red beam is incident on a first lenticular lens according to an embodiment of the disclosure.

FIG. 8 is a schematic of a third light spot area on a reference plane while a red beam is incident on a homogenizing module according to an embodiment of the disclosure.

FIG. 9 is a schematic of an angular distribution on a reference plane while a red beam is incident on a first lenticular lens according to an embodiment of the disclosure.

FIG. 10 is a schematic of an angular distribution on a reference plane while a red beam is incident on a homogenizing module according to an embodiment of the disclosure.

FIG. 11 is a schematic of example 1 of a double-sided microlens array according to an embodiment of the disclosure.

FIG. 12 is a schematic of example 2 of a double-sided microlens array according to an embodiment of the disclosure.

FIG. 13 is a schematic of example 3 of a double-sided microlens array according to an embodiment of the disclosure.

FIG. 14 is a relation schematic between an angular distribution and a light spot area on a reference plane while a red beam is incident on different elements according to an embodiment of the disclosure.

FIG. 15A is a schematic of a projection device according to an embodiment of the disclosure.

FIG. 15B is a schematic of a projection device according to another embodiment of the disclosure.

FIG. 16 is a schematic of a first color laser module according to an embodiment of the disclosure.

FIG. 17 is a schematic of a second color laser module according to an embodiment of the disclosure.

FIG. 18 is a schematic of a third color laser module according to an embodiment of the disclosure.

FIG. 19A is a schematic of a projection device according to an embodiment of the disclosure.

FIG. 19B is a schematic of a projection device according to another embodiment of the disclosure.

### DESCRIPTION OF THE INVENTION

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. The components of the disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

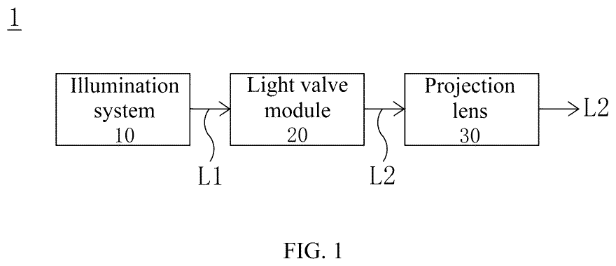

Please refer to FIG. 1. FIG. 1 is a block schematic of a projection device according to an embodiment of the disclosure. The projection device 1 includes an illumination system 10, a light valve module 20 and a projection lens 30. The illumination system 10 is configured to provide an illumination light beam L1 to the light valve module 20. The light valve module 20 is disposed on a transmission path of the illumination light beam L1. The light valve module 20 is configured to convert the illumination light beam L1 into an image beam L2 and to transmit the image beam L2 to the projection lens 30. The light valve module 20 may be a reflective light modulator such as a digital micromirror device (DMD) and a liquid crystal on silicon panel (LCoS panel), or a transmissive light modulator such as a transparent liquid crystal panel, an electro-optical modulator, a magneto-optic modulator or an acousto-optic modulator (AOM). The projection lens 30 is disposed on a transmission path of the image beam L2 from the light valve module 20. The projection lens 30 is configured to project the image beam L2 out of the projection device 1 to a projection target. The projection target is, for example, a screen or a wall. The projection lens 30 includes, for example, a combination of one or more optical lenses having diopter, such as various combinations of non-planar lenses such as a biconcave lens, a biconvex lens, a concave-convex lens, a convex-concave lens, a plano-convex lens, and a plano-concave lens. In other embodiments, the projection lens 30 may include a flat optical lens to project the image beam L2 to the projection target in a reflection manner. The disclosure does not limit the type and form of the projection lens 30.

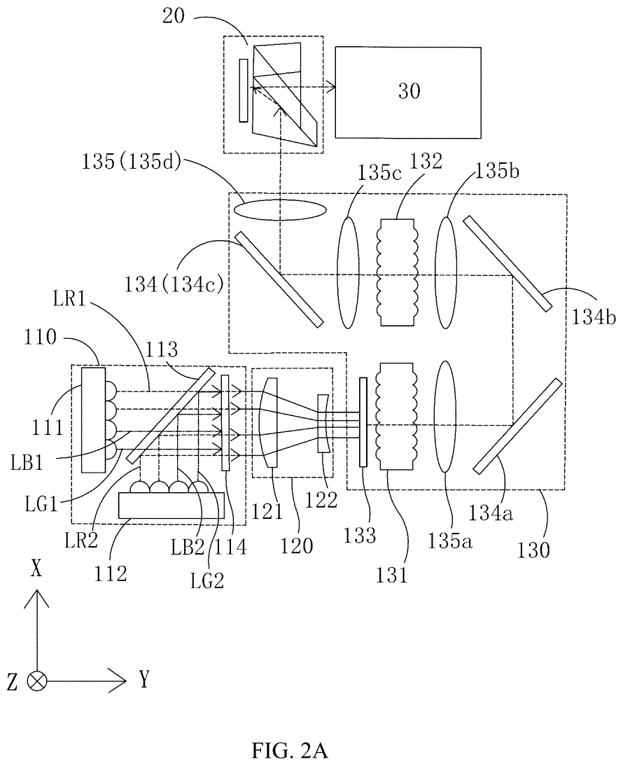

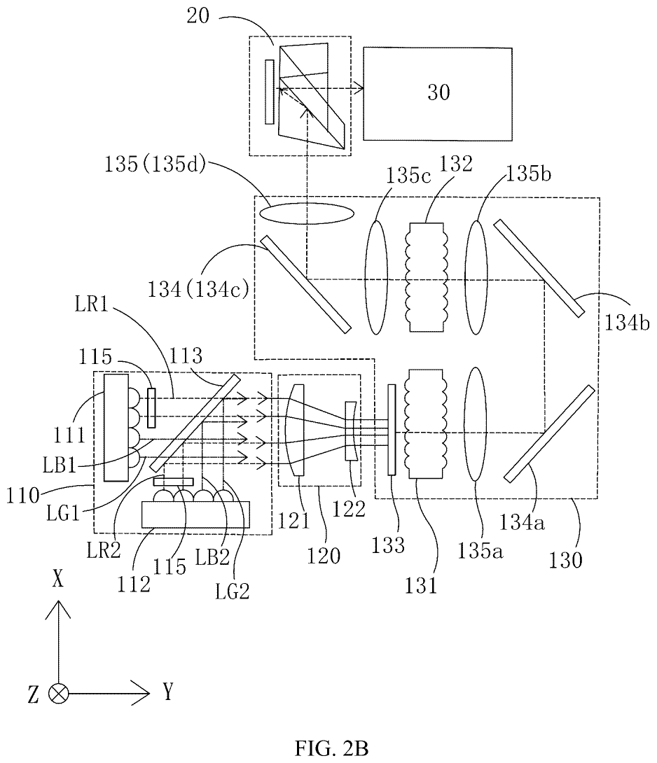

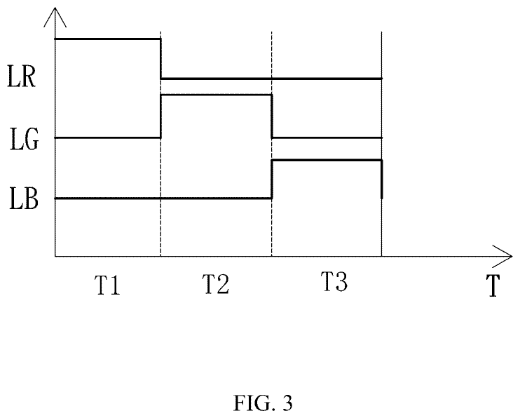

Please refer to FIG. 1, FIG. 2A and FIG. 3. FIG. 2A is a schematic of a projection device according to an embodiment of the disclosure. FIG. 3 is a schematic of a timing of a light beam according to an embodiment of the disclosure. A first direction X, a second direction Z and a third direction Y are shown in the figures to clearly show the viewing angle of each figure. The second direction Z is perpendicular to the first direction X, and the third direction Y is perpendicular to the first direction X and the second direction Z. The illumination system 10 of the projection device 1 includes a light source module 110, a light spot adjustment module 120, and a homogenizing module 130. The light source module 110 is configured to provide a red beam LR, a green beam LG and a blue beam LB respectively at different timings. Please refer to FIG. 3. The horizontal axis of FIG. 3 is time T. At timing T1 in one cycle, the light source module 110 provides the red beam LR and does not provide the green beam LG or the blue beam LB. At timing T2, the light source module 110 provides the green beam LG and does not provide the red beam LR or the blue beam LB. At timing T3, the light source module 110 provides the blue beam LB and does not provide the red beam LR or the green beam LG.

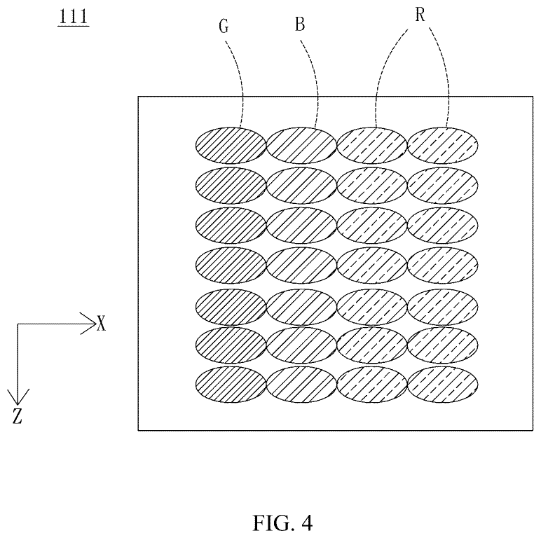

The light source module 110 includes a first laser module 111, a second laser module 112 and a first light combining element 113. The first laser module 111 and the second laser module 112 both include a plurality of red laser diodes R, a plurality of green laser diodes G, and a plurality of blue laser diodes B. Please refer to FIG. 4. FIG. 4 is a schematic of a laser module according to an embodiment of the disclosure. The first laser module 111 includes a column (along a second direction Z) of green laser diodes G, a column of blue laser diodes B and two columns of red laser diodes R arranged in sequence along the first direction X to form an array. In the embodiment, a number of the red laser diodes R is greater than a number of the green laser diodes G and a number of the blue laser diodes B. The distribution of the plurality of laser diodes in the second laser module 112 is the same as that in the first laser module 111 and thus will not be described in detail herein. The plurality of red laser diodes R are configured to provide the red beam LR. The plurality of green laser diodes G are configured to provide the green beam LG. The plurality of blue laser diodes B are configured to provide the blue beam LB. The first laser module 111 is configured to provide a first red beam LR1, a first green beam LG1, and a first blue beam LB1. The second laser module 112 is configured to provide a second red beam LR2, a second green beam LG2, and a second blue beam LB2. The red beam LR includes the first red beam LR1 and the second red beam LR2, the green beam LG includes the first green beam LG1 and the second green beam LG2, and the blue beam LB includes the first blue beam LB1 and the second blue beam LB2.

The first light combining element 113 is disposed on a transmission path of the first red beam LR1, the first green beam LG1, the first blue beam LB1, the second red beam LR2, the second green beam LG2 and the second blue beam LB2. The first light combining element 113 is configured to allow the first red beam LR1, the first green beam LG1 and the first blue beam LB1 to pass through and to reflect the second red beam LR2, the second green beam LG2 and the second blue beam LB2. The first red beam LR1, the first green beam LG1, the first blue beam LB1, the second red beam LR2, the second green beam LG2, and the second blue beam LB2 are transmitted to the light spot adjustment module 120. In this embodiment, the first red beam LR1, the first green beam LG1, the first blue beam LB1, the second red beam LR2, the second green beam LG2 and the second blue beam LB2 are transmitted to the light spot adjustment module 120 along the third direction Y.

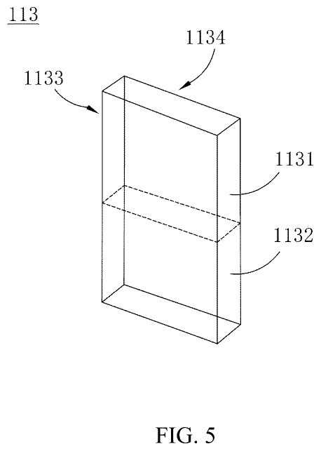

Please refer to FIG. 5. FIG. 5 is a schematic of a first light combining element according to an embodiment of the disclosure. The first light combining element 113 includes a first area 1131 and a second area 1132 which are adjacent to each other. The first area 1131 is configured to allow the first red beam LR1 from the first laser module 111 to pass through and to reflect the second green beam LG2 and the second blue beam LB2 from the second laser module 112. The second area 1132 is configured to allow the first green beam LG1 and the first blue beam LB1 from the first laser module 111 to pass through and to reflect the second red beam LR2 from the second laser module 112. In the embodiment, the first light combining element 113 is a partitioned dichroic mirror. The first light combining element 113 has a first surface 1133 and a second surface 1134 opposite to each other. The first laser module 111 is located on the same side as the first surface 1133 relative to the first light combining element 113. The second laser module 112 is located on the same side as the second surface 1134 relative to the first light combining element 113. That is, the first surface 1133 of the first light combining element 113 faces the first laser module 111, and the second surface 1134 of the first light combining element 113 faces the second laser module 112.

The light spot adjustment module 120 is disposed on a transmission path where the red beam LR is transmitted from the light source module 110 to the homogenizing module 130. The red beam LR (comprising the first red beam LR1 and the second red beam LR2) is incident on the light spot adjustment module 120 along the third direction Y. The light spot adjustment module 120 includes a first lenticular lens 121 and a second lenticular lens 122. The first lenticular lens 121 is disposed on a transmission path of the red beam LR which is transmitted from the light source module 110 to the second lenticular lens 122.

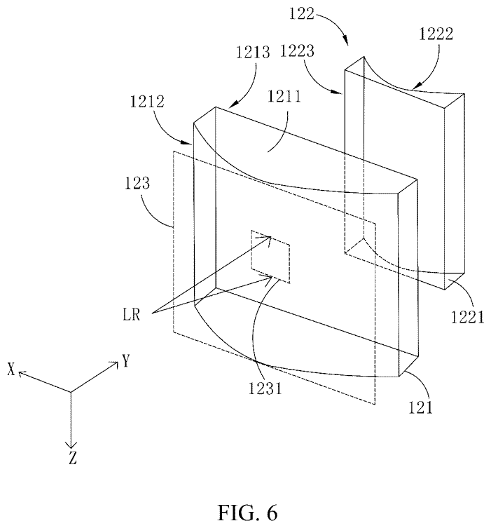

Please refer to FIG. 6. FIG. 6 is a schematic of a light spot adjustment module according to an embodiment of the disclosure. The first lenticular lens 121 includes a first column body 1211, a first surface 1212 and a first plane 1213. The first column body 1211 is formed by a single column body. The first surface 1212 is a surface on the first column body 1211 having a variable curvature. A column body extension direction of a first surface 1212 of the first column body 1211 is parallel to the second direction Z. The first plane 1213 is a surface of the first column body 1211 opposite to the first surface 1212. In other embodiments, the first plane 1213 may also be a curved surface but is not limited thereto. In one embodiment, one of the first surface 1212 and the first plane 1213 is a light incident surface, which is not limited to what is shown in FIG. 6. The curvature of the first surface 1212 changes along the first direction X. In the embodiment, the first lenticular lens 121 has a positive diopter power. The second lenticular lens 122 is disposed on a transmission path of the red beam LR which is transmitted from the first lenticular lens 121 to the homogenizing module 130. The second lenticular lens 122 includes a second column body 1221, a second surface 1222 and a second plane 1223. The second column body 1221 is formed by a single column body. The second surface 1222 is a surface having a variable curvature on the second column body 1221. A column body extension direction of the second surface 1222 of the second column 1221 is parallel to the second direction Z. The second plane 1223 is a surface of the second column body 1221 opposite to the second surface 1222. In other embodiments, the second plane 1223 may also be a curved surface but is not limited thereto. In one embodiment, one of the second surface 1222 and the second plane 1223 is a light emitting surface, which is not limited to what is shown in FIG. 6. The curvature of the second surface 1222 changes along the first direction X. In this embodiment, the second lenticular lens 122 has a negative dioptric power. The red beam LR is incident on the first lenticular lens 121 and the second lenticular lens 122 in sequence along the third direction (a direction parallel to an optical axis). In this embodiment, the red beam LR is incident on the first lenticular lens 121 from the first surface 1212 and is emitted from the second lenticular lens 122 from the second surface 1222. A reference plane 123 may be defined in the first direction X and the second direction Z. While the red beam LR is incident on the first lenticular lens 121, a spatial distribution of the red beam LR relative to the reference plane 123 forms a first light spot area 1231. While the red beam LR is incident on the first lenticular lens 121, an angular distribution of the red beam LR relative to the reference plane 123 has a major axis La. The major axis La is parallel to the second direction Z. The light spot adjustment module 120 is configured to reduce the first light spot area 1231.

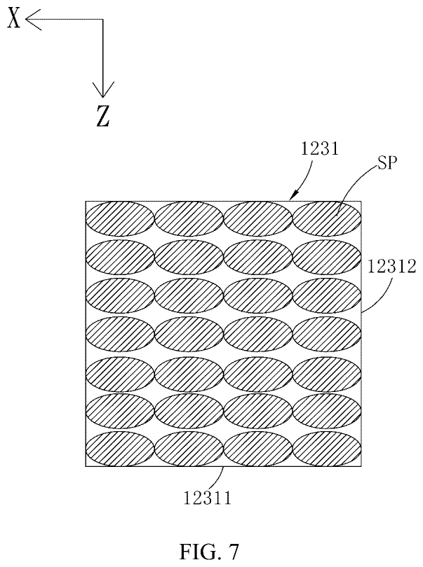

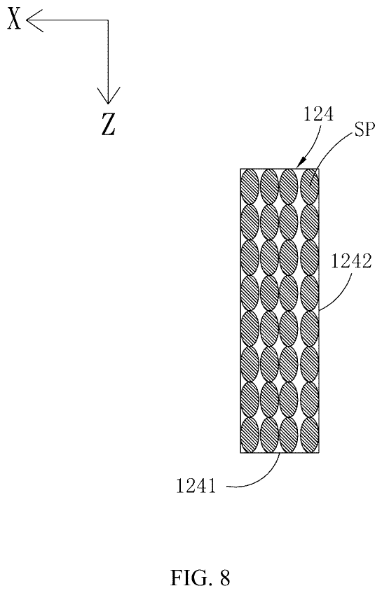

Please refer to FIG. 7 and FIG. 8. FIG. 7 is a schematic of a first light spot area 1231 on the reference plane 123 while the red beam LR is incident on the first lenticular lens 121 according to an embodiment of the disclosure. FIG. 8 is a schematic of a third light spot area 124 on the reference plane 123 while the red beam LR is incident on the homogenizing module 130 according to an embodiment of the disclosure. When the red beam LR is incident on the first lenticular lens 121, each of the plurality of red laser diodes R forms a light spot SP on the reference plane 123. The plurality of light spots SP are arranged to form the first light spot area 1231 on the reference plane 123. The first light spot area 1231 includes a light spot combination consisting of the plurality of light spots SP arranged along the first direction X and the second direction Z. In the embodiment, the first light spot area 1231 is a rectangle, and a first side 12311 and a second side 12312 adjacent to each other are defined. The first side 12311 is parallel to the first direction X, and the second side 12312 is parallel to the second direction Z. The first side 12311 and the second side 12312 have approximately the same length. A number of light spots (for example, 4) on the first side 12311 is smaller than a number of light spots (for example, 7) on the second side 12312. When the red beam LR passes through the light spot adjustment module 120 and is incident on the homogenizing module 130, a third light spot area 124 is formed relative to the reference plane 123. The third light spot area 124 includes a light spot combination arranged along the first direction X and the second direction Z. A first side 1241 and a second side 1242 adjacent to each other of the light spot area 124 are defined. The first side 1241 and the second side 1242 have different lengths. The length of the first side 1241 is shorter than the length of the second side 1242. In this embodiment, the light spot adjustment module 120 is configured to reduce the first light spot area 1231 in the first direction X. Therefore, when the red beam LR is incident on the homogenizing module 130, the length of the third light spot area 124 in the first direction X (the first side 1241) relative to the reference plane 123 is smaller than the length of the first side 12311 of the first light spot area 1231 relative to the reference plane 123. In other embodiments, the light spot adjustment module 120 may also be configured to reduce the first light spot area 1231 in different directions and is not limited to the above examples. Through the light spot adjustment module 120, when the red beam LR is incident on the homogenizing module 130, the spatial distribution (i.e., the light spot area) of the red beam LR relative to the reference plane 123 is reduced. Thereby, the etendue of the red beam LR on the homogenizing module 130 is reduced. Therefore, the homogenizing module 130 may completely receive the red beam LR from the light spot adjustment module 120 to improve the etendue utilization of the homogenizing module 130.

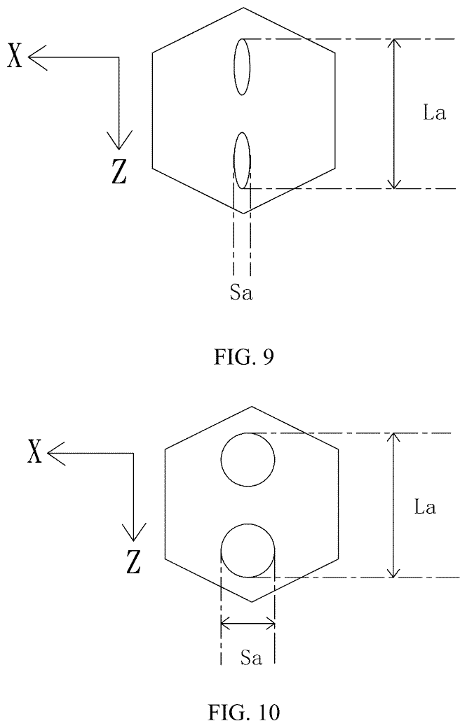

In one embodiment, the light spot adjustment module 120 may also be configured to expand the angular distribution of the red beam LR relative to the reference plane 123 while the red beam LR is incident on the homogenizing module 130. Please refer to FIG. 9 and FIG. 10. FIG. 9 is a schematic of the angular distribution of the red beam LR on the reference plane 123 while the red beam LR is incident on the first lenticular lens 121 according to an embodiment of the disclosure. FIG. 10 is a schematic of the angular distribution of the red beam LR on the reference plane 123 while the red beam LR is incident on the homogenizing module 130 according to an embodiment of the disclosure. In the embodiment, each of the plurality of red laser diodes R has a plurality of light-emitting chips (such as two light-emitting chips). The arrangement direction of the plurality of light-emitting chips is parallel to the second direction Z. In this way, when the red beam LR is incident on the first lenticular lens 121 of the light spot adjustment module 120, the angular distribution of the red beam LR on the reference plane 123 relative to the first lenticular lens 121 will have a major axis La and a minor axis Sa, and the arrangement direction of the plurality of light-emitting chips (i.e., the second direction Z) is parallel to the major axis La. The angular distribution of the red beam LR may be changed by designing the column body extension directions (i.e., the second direction Z) of the first surface 1212 and the second surface 1222 in the light spot adjustment module 120 to be the same as the extension direction of the major axis La, or by designing the variable curvature direction (i.e., the first direction X) of the first surface 1212 and the second surface 1222 in the light spot adjustment module 120 to be perpendicular to the extension direction of the major axis La (i.e., the second direction Z). As illustrated in FIG. 9 and FIG. 10, through the setting of the light spot adjustment module 120 of the embodiment, when the red beam LR is incident on the homogenizing module 130, the angular distribution of the red beam LR relative to the reference plane 123 is expanded (that is, the minor axis Sa is extended). That is, in the embodiment, the light spot adjustment module 120 is configured to expand the angular distribution of the minor axis Sa.

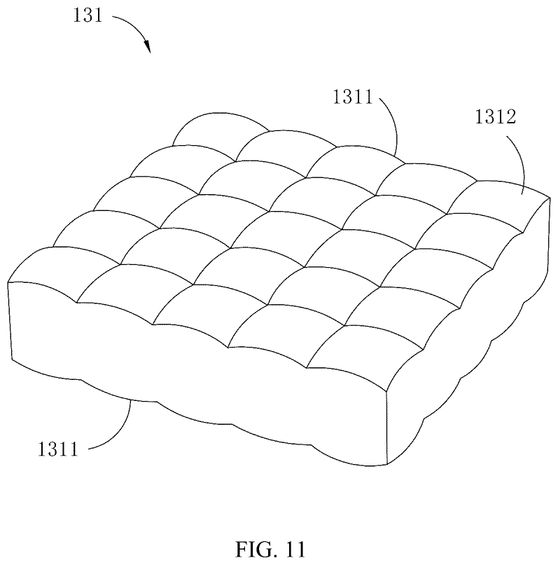

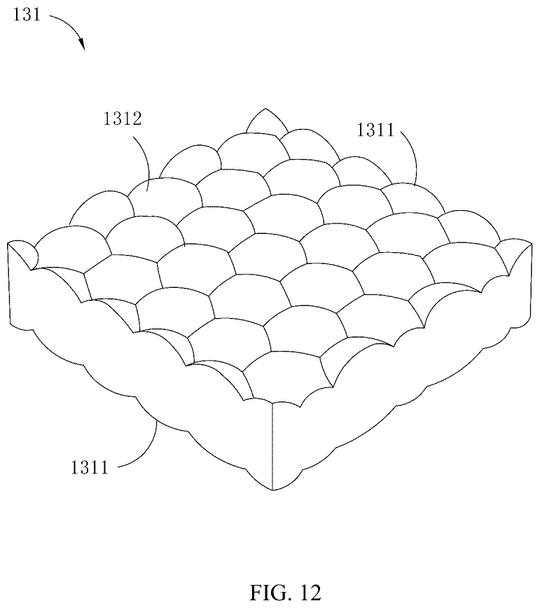

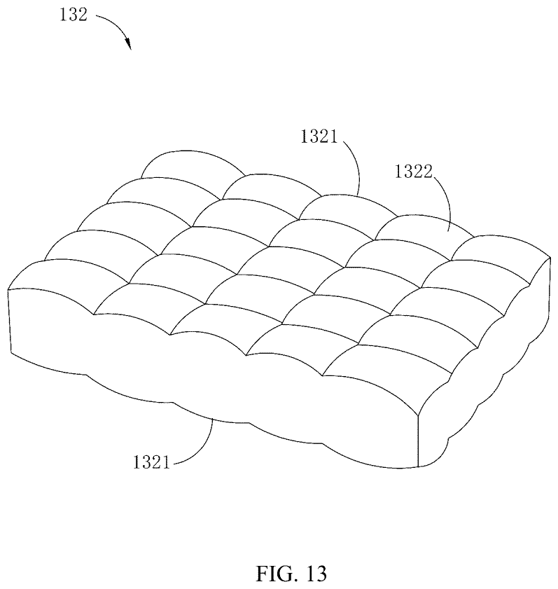

The homogenizing module 130 is configured to receive the red beam LR from the light spot adjustment module 120, the green beam LG and the blue beam LB and to uniformize the green beam LG, the blue beam LB and the red beam LR to generate the illumination light beam L1. In this embodiment, the homogenizing module 130 includes a first double-sided microlens array 131 and a second double-sided microlens array 132. The red beam LR, the green beam LG and the blue beam LB are transmitted to the second double-sided microlens array 132 via the first double-sided microlens array 131. Please refer to FIG. 11 to FIG. 13, which are schematic diagrams of double-sided microlens arrays according to different embodiments of the disclosure. The first double-sided microlens array 131 includes two opposite first surfaces 1311. Each of the two first surfaces 1311 includes a plurality of first microlenses 1312. A shape of an orthographic projection of each of the plurality of first microlenses 1312 on the reference plane 123 is a square or a hexagonal (as shown in FIG. 11 or FIG. 12). The second double-sided microlens array 132 includes two opposite second surfaces 1321. Each of the second surfaces 1321 includes a plurality of second microlenses 1322. A shape of an orthographic projection of each of the plurality of second microlenses 1322 on the reference plane 123 is a rectangle (as shown in FIG. 13).

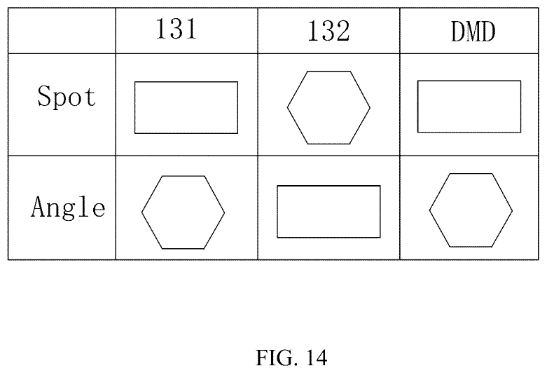

Furthermore, the shape of the orthographic projection of each of the plurality of second microlenses 1322 on the reference plane 123 corresponds to the shape of a second light spot area (not shown) which is formed by a spatial distribution of the red beam LR relative to the reference plane 123 while the red beam LR is incident on the first double-sided microlens array 131, both are rectangles, and the shape of the second light spot area is the same as the shape of the third light spot area 124. In an embodiment where the light valve module 20 includes at least one digital micromirror device (DMD), when the red beam LR is incident on the homogenizing module 130, the shape of the spatial distribution of the third light spot area 124 corresponds to the shape of the cell of the at least one digital micromirror device (DMD), both are rectangles. The first double-sided microlens array 131 and the second double-sided microlens array 132 convert the light beam in angle and space. As shown in FIG. 14, the second column represents that the red beam LR received by the first double-sided microlens array 131 has a rectangular light spot area (Spot) and a hexagonal angular distribution (Angle). The third column represents that the red beam LR received by the second double-sided microlens array 132 has a hexagonal light spot area and a rectangular angular distribution. The fourth column represents the light spot area of the red beam LR received by the digital micromirror device (DMD) having a rectangular spatial distribution and a hexagonal angular distribution.

The homogenizing module 130 further includes a speckle reduction unit 133. The speckle reduction unit 133 is disposed between the light spot adjustment module 120 and the first double-sided microlens array 131 and is located on the transmission path of the red beam LR. The speckle reduction unit 133 is, for example, a laser speckle reducer (LSR). The homogenizing module 130 further includes at least one light guiding element 134 and at least one lens 135. The light guiding element 134 is, for example, a reflector. The at least one light guiding element 134 is disposed between the first double-sided microlens array 131 and the light valve module 20 and on the transmission path of the red beam LR, the green beam LG and the blue beam LB. The at least one lens 135 is disposed between the first double-sided microlens array 131 and the light valve module 20 and is located on the transmission path of the red beam LR, the green beam LG and the blue beam LB. Taking FIG. 2A as an example, a lens 135a, a light guiding element 134a, a light guiding element 134b and a lens 135b are sequentially arranged between the first double-sided microlens array 131 and the second double-sided microlens array 132. A lens 135c, a light guiding element 134c and a lens 135d are sequentially disposed between the second double-sided microlens array 132 and the light valve module 20.

In one embodiment, the light source module 110 further includes a depolarization element 114. The depolarization element 114 is disposed between the first light combining element 113 and the light spot adjustment module 120. The depolarization element 114 is, for example, a depolarizer. The polarization states of the red beam LR, the green beam LG and the blue beam LB are eliminated by the depolarization element 114.

In another embodiment, as shown in FIG. 2B, the light source module 110 is not provided with the depolarization element 114. Instead, the light source module 110 further includes two polarization elements 115. The two polarization elements 115 are respectively disposed on a transmission path of the first red beam LR1 which is transmitted from the first laser module 111 to the first light combining element 113 and a transmission path of the second red beam LR2 which is transmitted from the second laser module 112 to the first light combining element 113. The two polarization elements 115 are configured to convert the polarization states of the first red light beam LR1 and the second red beam LR2. Thus, the first red beam LR1 and the second red beam LR2 have the same polarization state as the blue beam LB and the green beam LG. The two polarization elements 115 are, for example, a half wave plate. In other embodiments, two polarization elements are respectively disposed on the transmission path of the first blue beam LB1 and the first green beam LG1 which is transmitted from the first laser module 111 to the first light combining element 113, and the transmission path of the second blue beam LB2 and the second green beam LG2 which is transmitted from the second laser module 112 to the first light combining element 113. The two polarization elements are configured to convert the polarization states of the blue beam LB and the green beam LG such that the blue beam LB and the green beam LG have the same polarization state as the red beam LR but are not limited thereto.

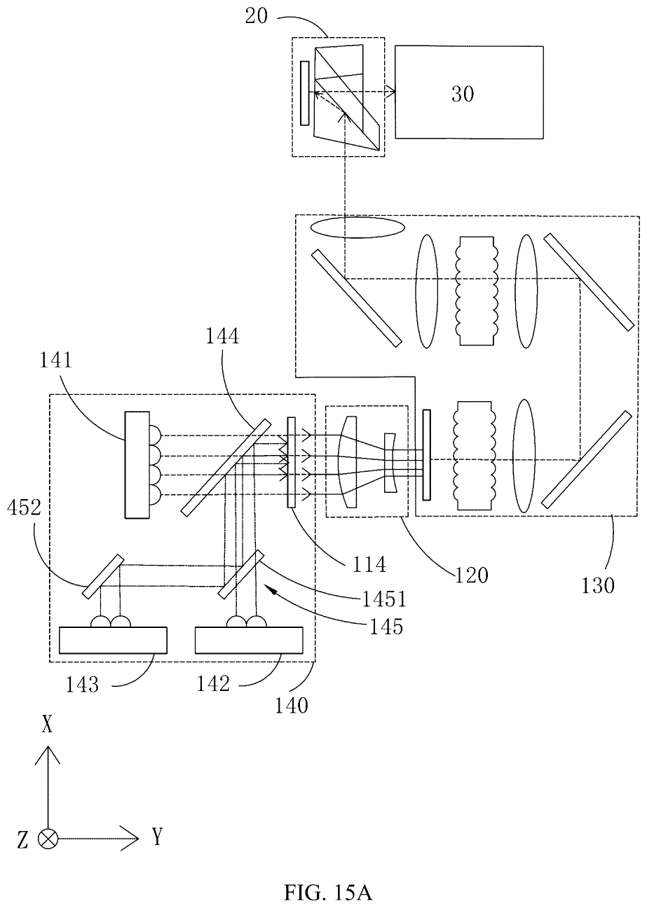

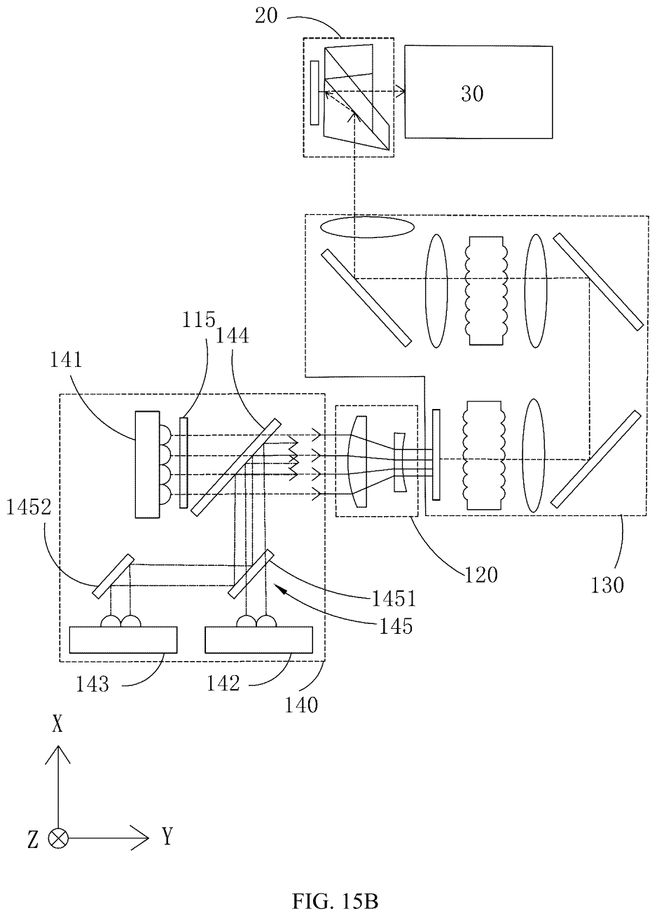

Please refer to FIG. 15A, which is a schematic diagram of a projection device according to an embodiment of the present invention. The projection device in FIG. 15A has a similar structure to that of the projection device in FIG. 2A, and the same elements are numbered the same and will not be described again. The difference between FIG. 15A and FIG. 2A is that the illumination system 10 includes a light source module 140. The light source module 140 includes a first color laser module 141, a second color laser module 142, a third color laser module 143, a second light combining element 144 and a blue-green light guiding component 145. The first color laser module 141 is configured to provide the red beam LR. The second color laser module 142 is configured to provide the blue beam LB. The third color laser module 143 is configured to provide the green beam LG. The second light combining element 144 is disposed on a transmission path of the red beam LR which is transmitted from the first color laser module 141 to the light spot adjustment module 120. The blue-green light guiding component 145 is disposed on a transmission path of the blue beam LB which is transmitted from the second color laser module 142 to the second light combining element 144 and on a transmission path of the green beam LG which is transmitted from the third color laser module 143 to the second light combining element 144. The second light combining element 144 is configured to allow the red beam LR to pass through and to reflect the blue beam LB and the green beam LG from the blue-green light guiding component 145 so that the red beam LR, the blue beam LB and the green beam LG are transmitted to the light spot adjustment module 120. The second light combining element 144 is, for example, a dichroic mirror.

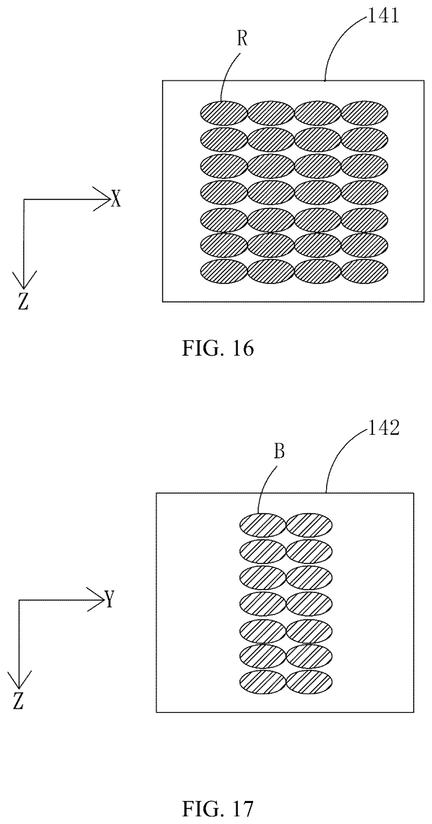

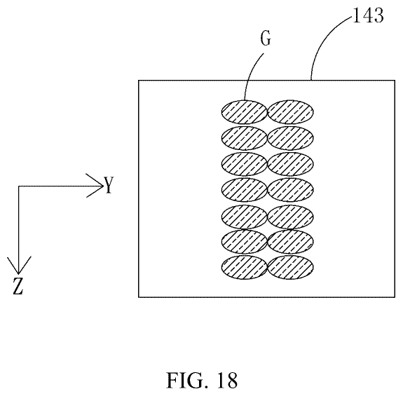

Please refer to FIG. 16 to FIG. 18. FIG. 16 is a schematic of a first color laser module according to an embodiment of the disclosure. FIG. 17 is a schematic of a second color laser module according to an embodiment of the disclosure. FIG. 18 is a schematic of a third color laser module according to an embodiment of the disclosure. The first color laser module 141 includes a plurality of red laser diodes R. A plurality of red laser diodes R are arranged in an array along the first direction X and the second direction Z. The number of red laser diodes R arranged along the first direction X (for example, four red laser diodes R) is different from the number of red laser diodes R arranged along the second direction Z (for example, seven red laser diodes R). The second color laser module 142 includes a plurality of blue laser diodes B. The plurality of blue laser diodes B are arranged in an array along the third direction Y and the second direction Z. The number of blue laser diodes B arranged along the third direction Y (for example, two blue laser diodes B) is different from the number of blue laser diodes B arranged along the second direction Z (for example, seven blue laser diodes B). The third color laser module 143 includes a plurality of green laser diodes G. A plurality of green laser diodes G are arranged in an array along the third direction Y and the second direction Z. The number of green laser diodes G arranged along the third direction Y (for example, two green laser diodes G) is different from the number of green laser diodes G arranged along the second direction Z (for example, seven green laser diodes G).

Please refer to FIG. 15A. The light source module 140 further includes a depolarization element 114. The depolarization element 114 is disposed between the second light combining element 144 and the light spot adjustment module 120. The depolarization element 114 is, for example, a depolarizer. The polarization states of the red beam LR, the green beam LG and the blue beam LB are eliminated by the depolarization element 114. In another embodiment, as shown in FIG. 15B, the light source module 140 is not provided with the depolarization element 114. Instead, the light source module 140 further includes a polarization element 115. The polarization element 115 is disposed on a transmission path of the red beam LR which is transmitted from the first color laser module 141 to the second light combining element 144. The polarization element 115 is configured to convert the polarization state of the red beam LR so that the red beam LR has the same polarization state as the blue beam LB and the green beam LG. The polarization element 115 is, for example, a half wave plate. In other embodiments, the polarization element is disposed on a transmission path of the blue beam LB and the green beam LG which are transmitted from the blue-green light guiding component 145 to the second light combining element 144. The polarization states of the blue beam LB and the green beam LG may be converted so that the blue beam LB and the green beam LG have the same polarization state as the red beam LR but are not limited thereto.

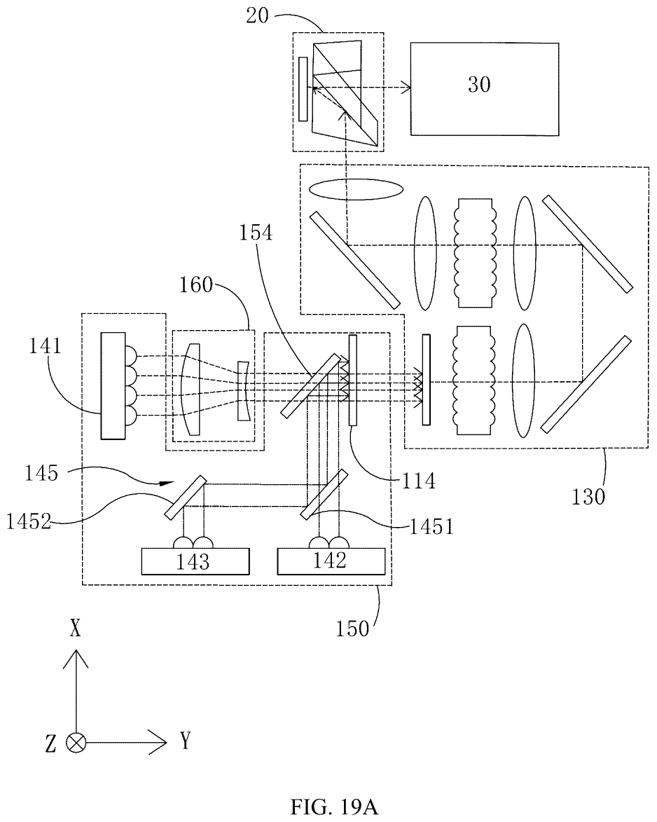

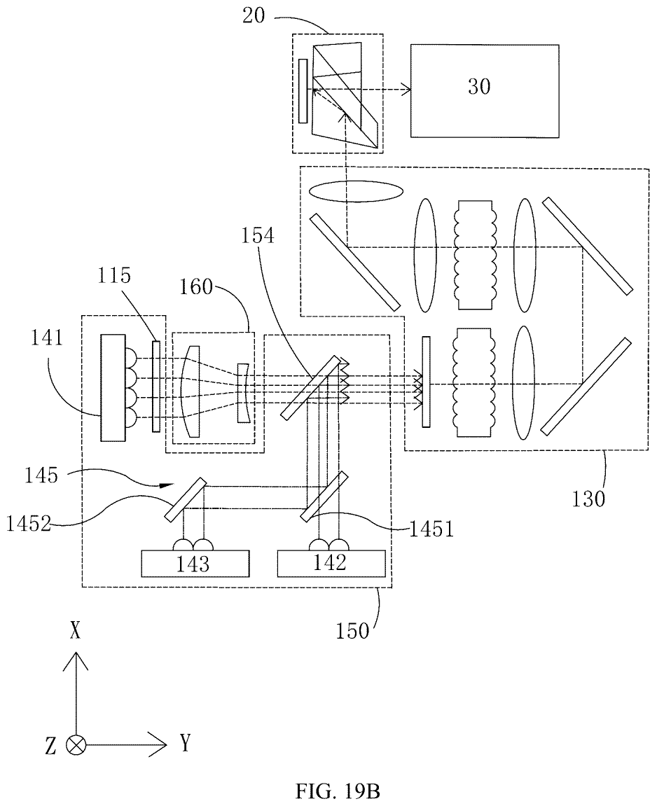

The blue-green light guiding component 145 includes a blue light guiding element 1451 and a green light guiding element 1452. The green light guiding element 1452 is configured to reflect the green beam LG from the third color laser module 143 to transmit the green beam LG to the blue light guiding element 1451. In this embodiment, the green light guiding element 1452 is, for example, a reflector. The blue light guiding element 1451 is configured to allow the blue beam LB from the second color laser module 142 to pass through and to reflect the green beam LG from the green light guiding element 1452 so that the green beam LG and the blue beam LB are transmitted to the second light combining element 144. In this embodiment, the blue light guiding element 1451 is, for example, a dichroic mirror. In other embodiments, the positions of the second color laser module 142 and the third color laser module 143 may be interchanged. Therefore, the positions of the blue light guiding element 1451 and the green light guiding element 1452 may also be exchanged. In the embodiment, the blue light guiding element 1451 may be implemented by a reflector, and the green light guiding element 1452 may be implemented by a dichroic mirror, but the disclosure is not limited thereto. Please refer to FIG. 19A. FIG. 19A is a schematic of a projection device according to an embodiment of the disclosure. FIG. 19A and FIG. 15A present similar structures, and the same elements are numbered the same and will not be described again. The difference between FIG. 19A and FIG. 15A is that the illumination system 10 includes a light source module 150 and a light spot adjustment module 160. The light source module 150 includes a first color laser module 141, a second color laser module 142, a third color laser module 143, a second light combining element 154, and a blue-green light guiding component 145. The light spot adjustment module 160 is located between the first color laser module 141 and the second light combining element 154. The light spot adjustment module 160 is on the transmission path of the red beam LR. The light spot adjustment module 160 is not located on the transmission path of the blue beam LB and the green beam LG. The second light combining element 154 is disposed on a transmission path of the red beam LR which is transmitted from the first color laser module 151 to the homogenizing module 130. The second light combining element 154 allows the red beam LR to pass through and reflects the blue beam LB and the green beam LG from the blue-green light guiding component 145 so that the red beam LR, the blue beam LB and the green beam LG are transmitted to the homogenizing module 130. In the embodiment, the red beam LR provided by the first color laser module 141 passes through the light spot adjustment module 160 and the second light combining element 154 in sequence and then enters the homogenizing module 130.

The light source module 150 further includes a depolarization element 114. The depolarization element 114 is disposed between the second light combining element 154 and the homogenizing module 130. The depolarization element 114 is, for example, a depolarizer. The polarization states of the red beam LR, the green beam LG and the blue beam LB are eliminated by the depolarization element 114. In another embodiment, as shown in FIG. 19B, the light source module 150 is not provided with the depolarization element 114. Instead, the light source module 150 further includes a polarization element 115. The polarization element 115 is disposed on a transmission path of the red beam LR which is transmitted from the first color laser module 141 to the second light combining element 154. The polarization element 115 is configured to convert the polarization state of the red beam LR so that the red beam LR has the same polarization state as the blue beam LB and the green beam LG. The polarization element 115 is, for example, a half wave plate. In other embodiments, a polarization element is disposed on a transmission path of the blue beam LB and the green beam LG which is transmitted from the blue-green light guiding component 145 to the second light combining element 154. The polarization element 115 is configured to convert the polarization states of the blue beam LB and the green beam LG so that the blue beam LB and the green beam LG have the same polarization state as the red beam LR but is not limited thereto.

According to the above, the embodiments of the disclosure at least have one of the following beneficial effects: The embodiment of the disclosure provides an illumination system and a projection device to allow a spatial distribution of a red beam to be reduced while the red beam is incident on the homogenizing module, so that an etendue of the red beam relative to the homogenizing module to be reduced. Therefore, the utilization of the etendue of the homogenizing module is improved.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the invention”, “the disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the disclosure is intended to be dedicated to the public regardless of whether the element or component is explicitly recited in the following claims.

1. An illumination system, for providing an illumination light beam, comprising:
a light source module, a light spot adjustment module and a homogenizing module, wherein:
the light source module is configured to provide a red beam, a green beam and a blue beam respectively at different timings;
the light spot adjustment module is disposed on a transmission path of the red beam which is transmitted from the light source module to the homogenizing module, the light spot adjustment module comprises a first lenticular lens and a second lenticular lens, the first lenticular lens is disposed on a transmission path of the red beam which is transmitted from the light source module to the second lenticular lens, the first lenticular lens comprises a first surface with a variable curvature, a curvature of the first surface changes along a first direction, the second lenticular lens is disposed on a transmission path of the red beam which is transmitted from the first lenticular lens to the homogenizing module, the second lenticular lens comprises a second surface with a variable curvature, a curvature of the second surface changes along the first direction, a column body extension direction of the first surface and a column body extension direction of the second surface are parallel to a second direction, the second direction is perpendicular to the first direction, the first direction and the second direction form a reference plane, a spatial distribution of the red beam relative to the reference plane forms a first light spot area while the red beam is incident on the first lenticular lens, an angular distribution of the red beam relative to the reference plane has a major axis while the red beam is incident on the first lenticular lens, the major axis is parallel to the second direction, and the light spot adjustment module is configured to reduce the first light spot area; and
the homogenizing module is configured to receive the red beam from the light spot adjustment module, the green beam and the blue beam and to homogenize the green beam, the blue beam and the red beam to generate the illumination light beam.

2. The illumination system as claimed in claim 1, wherein the first lenticular lens has a positive diopter power and the second lenticular has a negative dioptric power.

3. The illumination system as claimed in claim 1, wherein the red beam is incident on the light spot adjustment module in the third direction, and the first direction and the second direction are perpendicular to the third direction.

4. The illumination system as claimed in claim 1, wherein the homogenizing module comprises a first double-sided microlens array and a second double-sided microlens array, and the red beam, the green beam and the blue beam are transmitted to the second double-sided microlens array through the first double-sided microlens array.

5. The illumination system as claimed in claim 4, wherein the first double-sided microlens array comprises two first surfaces opposite to each other, each of the two first surfaces comprises a plurality of first microlenses, an orthographic projection of each of the plurality of first microlenses on the reference plane is a hexagonal or a square, and the second double-sided microlens array comprises two second surfaces opposite to each other, each of the two second surfaces comprises a plurality of second microlenses, and an orthographic projection of each of the plurality of second microlenses on the reference plane is a rectangle.

6. The illumination system as claimed in claim 5, wherein a shape of the orthographic projection of each of the plurality of second microlenses on the reference plane is corresponding to a shape of a second light spot area relative to the reference plane, wherein the second light spot area is formed by a spatial distribution of the red beam while the red beam is incident on the first double-sided microlens array.

7. The illumination system as claimed in claim 1, wherein the light source module comprises a first laser module, a second laser module, and a first light combining element, the first laser module is for providing a first red beam, a first green beam and a first blue beam, the second laser module is for providing a second red beam, a second green beam and a second blue beam, the red beam comprises the first red beam and the second red beam, the green beam comprises the first green beam and the second green beam, the blue beam comprises the first blue beam and the second blue beam, the first light combining element is disposed on a transmission path of the first red beam, the first green beam, the first blue beam, the second red beam, the second green beam and the second blue beam, and the first light combining element is configured to allow the first red beam, the first green beam and the first blue beam to pass through and to reflect the second red beam, the second green beam and the second blue beam such that the first red beam, the first green beam, the first blue beam, the second red beam, the second green beam and the second blue beam are transmitted to the light spot adjustment module.

8. The illumination system as claimed in claim 7, wherein the first light combining element comprises a first area and a second area, the first area is configured to allow the first red beam from the first laser module to pass through and to reflect the second green beam and the second blue beam from the second laser module, and the second area is configured to allow the first green beam and the first blue beam from the first laser module to pass through and to reflect the second red beam from the second laser module.

9. The illumination system as claimed in claim 7, wherein the light source module further comprises a depolarization element, and the depolarization element is disposed between the first light combining element and the light spot adjustment module.

10. The illumination system as claimed in claim 7, wherein the light source module further comprises two polarization elements, and the two polarization elements are respectively disposed on a transmission path of the first red beam which is transmitted from the first laser module to the first light combining element and a transmission path of the second red beam which is transmitted from the second laser module to the first light combining element.

11. The illumination system as claimed in claim 1, wherein the light source module comprises a first color laser module, a second color laser module, a third color laser module, a second light combining element and a blue-green light guiding component, the first color laser module is configured to provide the red beam, the second color laser module is configured to provide the blue beam, the third color laser module is configured to provide the green beam, the second light combining element is disposed on a transmission path of the red beam which is transmitted from the first color laser module to the light spot adjustment module, the blue-green light guiding component is disposed on a transmission path of the blue beam which is transmitted from the second color laser module to the second light combining element and a transmission path of the green beam which is transmitted from the third color laser module to the second light combining element, and the second light combining element is configured to allow the red beam to pass through and to reflect the blue beam and the green beam from the blue-green light guiding component such that the red beam, the blue beam and the green beam are transmitted to the light spot adjustment module.

12. The illumination system as claimed in claim 11, wherein the light source module further comprises a depolarization element, and the depolarization element is disposed between the second light combining element and the light spot adjustment module.

13. The illumination system as claimed in claim 11, wherein the light source module further comprises a polarization element, and the polarization element is disposed on a transmission path of the red beam which is transmitted from the first color laser module to the second light combining element.

14. The illumination system as claimed in claim 11, wherein the blue-green light guiding component comprises a blue light guiding element and a green light guiding element, the green light guiding element is configured to reflect the green beam from the third color laser module to transmit the green beam to the blue light guiding element, and the blue light guiding element is configured to allow the blue beam from the second laser module to pass through and to reflect the green beam from the green light guiding element to transmit the green beam and the blue beam to the second light combining element.

15. The illumination system as claimed in claim 1, wherein the light source module comprises a first color laser module, a second color laser module, a third color laser module, a second light combining element and a blue-green light guiding component, the first color laser module is configured to provide the red beam, the second color laser module is configured to provide the blue beam, the third laser module is configured to provide the green beam, the second light combining element is disposed on a transmission path of the red beam which is transmitted from the first color laser module to the homogenizing module, the light spot adjustment module is disposed between the first color laser module and the second light combining element, the red beam from the first color laser module passes through the light spot adjustment module and the second light combining element in sequence and then enters the homogenizing module, the blue-green light guiding component is disposed on a transmission path of the blue beam which is transmitted from the second color laser module to the second light combining element and a transmission path of the green beam which is transmitted from the third color laser module to the second light combining element, and the second light combining element is configured to allow the red beam to pass through and to reflect the blue beam and the green beam from the blue-green light guiding component for transmitting the red beam, the green beam and the blue beam to the homogenizing module.

16. The illumination system as claimed in claim 15, wherein the light source module further comprises a depolarization element, and the depolarization element is disposed between the second light combining element and the homogenizing module.

17. The illumination system as claimed in claim 15, wherein the light source module further comprises a polarization element, and the polarization element is disposed on a transmission path of the red beam which is transmitted from the first color laser module to the second light combining element.

18. The illumination system as claimed in claim 15, wherein the blue-green light guiding component comprises a blue light guiding element and a green light guiding element, the green light guiding element is configured to reflect the green beam from the third color laser module to transmit the green beam to the blue light guiding element, and the blue light guiding element is configured to allow the blue beam from the second color laser module to pass through and to reflect the green beam from the green light guiding element to transmit the green beam and the blue beam to the second light combining element.

19. The illumination system as claimed in claim 1, wherein the light source module comprises a plurality of red diodes for providing the red beam, each of the plurality of red diodes has a plurality of light-emitting chips, and an arrangement direction of the plurality of light-emitting chips is parallel to the major axis of the angular distribution of the red beam relative to the reference plane while the red beam is incident on the first lenticular lens.

20. The illumination system as claimed in claim 1, wherein the first light spot area relative to the reference plane is rectangular while the red beam is incident on the first lenticular lens, the first light spot has a first side and a second side, the first side is adjacent to the second side, the first side is parallel to the first direction, the second side is parallel to the second direction, the first light spot area is formed by a plurality of red light spots arranged in an array, and a number of light spots on the first side is less than a number of light spots on the second side.

21. The illumination system as claimed in claim 20, wherein the light spot adjustment module is configured to reduce the first light spot area in the first direction, a spatial distribution of the red beam relative to the reference plane forms a third light spot area while the red beam is incident on the homogenizing module, and a length of the third light spot area relative to the reference plane in the first direction is less than a length of the first side of the first light spot area.

22. The illumination system as claimed in claim 1, wherein the angular distribution of the red beam relative to the reference plane has a minor axis while the red beam is incident on the first lenticular lens and the light spot adjustment module is configured to expand the minor axis.

23. A projection device, comprising the illumination system as claimed in claim 1, a light valve module and a lens module, wherein,
the illumination system is configured to generate the illumination light beam;
the light valve module is disposed on a transmission path of the illumination light beam for converting the illumination light beam into an image beam; and
the lens module is disposed on a transmission path of the image beam, and the lens module is configured to project the image beam from the light valve module out of the projection device.

24. The projection device as claimed in claim 23, wherein the light valve module comprises at least one digital micromirror device, and a shape of a third light spot area is corresponding to a shape of a cell of the digital micromirror device, wherein the third light spot area is formed by a spatial distribution of the red beam relative to the reference plane while the red beam is incident on the homogenizing module.
